(19) United States
(12) Patent Application Publication
(10) Pub. No.: US 2015/0261883 A1
(43) Pub. Date: Sep. 17, 2015

(54) Information Context Descriptions and the Collaborative Research Engine

(71) Applicant: Andrew S. Wigodsky, Omaha, NE (US)

(72) Inventor: Andrew S. Wigodsky, Omaha, NE (US)

(21) Appl. No.: 14/207,662

(22) Filed: Mar. 13, 2014

(51) Int. Cl. G06F 17/30

(52) U.S. Cl. CPC G06F 17/30935; G06F 17/30864

(57) ABSTRACT

Disclosed is a method and apparatus that provides the ability to perform collaborative research by automating a system to create, secure, obtain, process, transmit, receive, publish, subscribe to, or otherwise communicate contextual descriptions, comprising context-enabled electronic search and research results. This research information comprises both previously known and unknown sources of unstructured or structured data that is either unclassified, or is strongly or loosely classified according one or a plurality of known or generated contexts, taxonomies, schemas, statistical, hierarchical, or referential models.

### BACKGROUND OF THE INVENTION

Early in the days of the Internet, information seemed finite. Information was stored on individual servers; a user needed an account to access that server, and a location to retrieve the file. The process was arduous: people who knew of a particular program or information store would send a mail to a person or people who needed to find it. Emails started to fly; People posted messages on their favorite Usenet lists. Soon, the process for finding information was too slow for the people who needed it to make important and often urgent decisions: about defense research, scientific exploration, education, government, and the world's largest corporations.

Not too long before websites started popping up on billboards came the gopher protocol and application. Gopher, and then hypertext-based lynx, presented a user with text containing embedded hyperlinks that would quickly shepherd the searcher to the information they required. By adding pictures and layout rules to gopher the first “web browser” was soon downloadable by ftp or gopher from mirror sites everywhere. Soon, information was ubiquitous. Corporations and individuals and governments and families and friendship circles each consume and produce massive amounts of information on the Internet. Still, decades later, organizations and individuals looking to find their way in that information are generally met with a single search box in which they are seemingly meant to describe everything they want to find.

The detrimental effects of the “text box” on Internet searching is simple: users are forced to choose between thinking up longer and longer search terms, or clicking through many pages of results mixed in with advertisements, in order to find what they are looking for. Whether searching for a vague concept or researching for the detailed answer to a technical problem, the current incarnation of search engines use the same methods and are all variations of a common theme: a list of links with text, pictures, and advertisements that contain the keywords a user seeks. Users performing detailed, ongoing research using the Internet have few tools at their disposal beyond traditional search engines to find the information they need.

### SUMMARY OF THE INVENTION

Disclosed is a summary of claims related to methods and apparatuses that provide the ability to perform collaborative research and other information gathering activities by facilitating access to relevant information through exchanges and refinement of statistically described hierarchical clusters of keywords, key phrases, and related metadata. The research provided by this invention could comprise information such as documents, email and other electronic communications, hypertext, links to files or document stores, images, multimedia, information in a database, or data available through web services.

This invention operates primarily by automating a system to create, secure, obtain, process, transmit, receive, publish, subscribe to, and/or otherwise communicate contextual descriptions. The primary component of this system is an information context description, comprising context-enabled electronic search and research results. The research results gathered by this invention comprise both previously known and unknown sources of unstructured or structured data that is either unclassified, or is strongly or loosely classified. Information classification performed by this invention can be according one or a plurality of known or generated contexts, taxonomies, schemas, statistical, hierarchical, and/or referential models.

One optimal embodiment of this invention comprises the following steps:
responsive to receiving an inquiry;
querying a user to describe the desired research results in terms of key words and phrases in at least one statistical, hierarchical, or referential model;
generate an initial context description comprising one or a plurality of statistical, hierarchical, and reference models;
obtaining the configuration for a particular query and querying at least one storage, processing, or communications medium;
obtaining the context description for one or a plurality of related context descriptions;
discovering, obtaining, and processing context descriptions and associated content or content exemplars from one or a plurality of available documents, electronic communications, web pages, personal device stores, commercial research stores, and organizational information stores;
indexing, storing, processing, and/or communicating indexes that link context descriptions and information stores;
presenting research to a user and enabling a user to refine the previous inquiry;
communicating any new or updated research inquiry.

Aspects of the invention can comprise a computer implemented method, wherein if a known context description is not found, one or a plurality of research processing agents can process steps to prompt the user to generate a new context description from potentially related content in known information stores. These known information stores, in an optimal embodiment, further comprise of one or a plurality of user-specific and general information stores. Information stores can comprise publicly and privately available web pages and other types of network-accessible information feeds, personal device stores, commercial research stores, organizational information stores, and other stores of structured or unstructured information.

Processing steps in this invention can be performed by research processing agents that can comprise software components or devices for:
obtaining and aggregating content;
clustering context descriptions of content sources;
clustering context descriptions of index sources; and
in an optimal embodiment, communicating context descriptions using a communications medium.

The processing steps of research processing agents can further comprise an electronic agent or service for obtaining and aggregating content, comprising:
calculating content index clusters needing updates;
sending and receiving clusters of information needing updates;
sending and receiving content needing clustering; and
in an optimal embodiment, listening on a network for and subsequently processing cluster updates.

The processing steps of clustering context descriptions of content sources further can comprise clustering source data and identifying sources to review for further indexing. The processing steps can also comprise a processing step of clustering context descriptions of index sources and can further comprise performing index clustering and identifying indexes requiring source updates.

The processing step of communicating context descriptions can use a communications medium to further process information. The process for this communication comprises a method for calculating context descriptions needing updates, and a method for sending and receiving context description updates.

A computer implemented method or other device-implemented method allows the user to store and use indexes and reference models to accelerate further research, comprising indexes of content, indexes of context descriptions, or hybrid indexes comprising indexes of both content and context descriptions. In another aspect, the reference models can further comprise hyperlinks to content exemplars or previously sampled content, and can comprise context descriptions for the referenced content and exemplars.

The system can provide a method of publishing research services comprising context-enabled content, and, in an optimal embodiment, this context-enabled content comprises: content with an embedded context description, context descriptions with embedded content, or context descriptions with embedded hyperlinks to content. The published context-enabled content will often comprise context-enabled content stored or owned by a particular individual or other entity such as organizations, public or private entities, or commercial services.

In an optimal embodiment, the system communicates with a network for brokering, exchanging, trading, sharing, and/or selling one or a plurality of context descriptions, associated content, and/or exemplars using a communications network. The network further comprises a communications system that connects a plurality of computing devices allowing exchange of content and context descriptions. This communication, in an optimal embodiment, comprises standards for electronic communication of context-enabled information using Internet Protocols that can be used to describe object notation and web services.

One aspect of this invention is a method or device for storing information content that can enable one or a plurality of embodiment-specific features comprising security, privacy, access control, statistical sampling, metadata analysis, extraction of content exemplars, acquisition scheduling, and researcher workflow.

Research generated by this invention can comprise textually and graphically represented information context descriptions displayed to a user, comprising one or a plurality of discovered information content, links to content, and suggestions for further refining research.

Further aspects of the invention will become apparent from consideration of the drawings and descriptions of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### BRIEF DESCRIPTION OF THE DRAWINGS

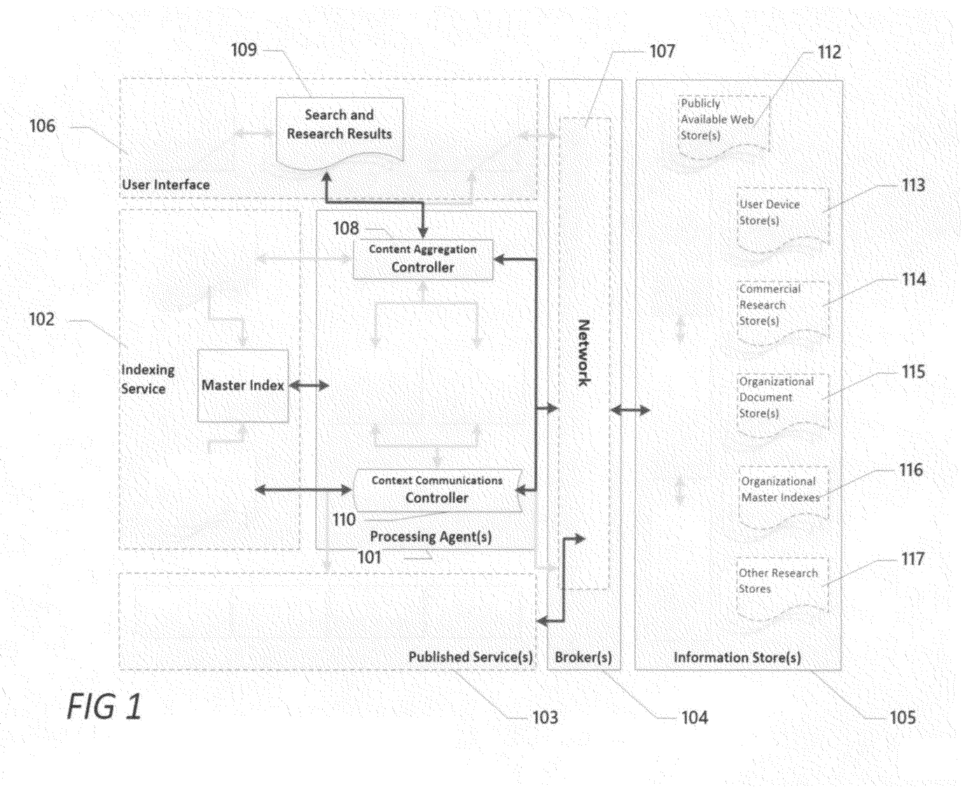

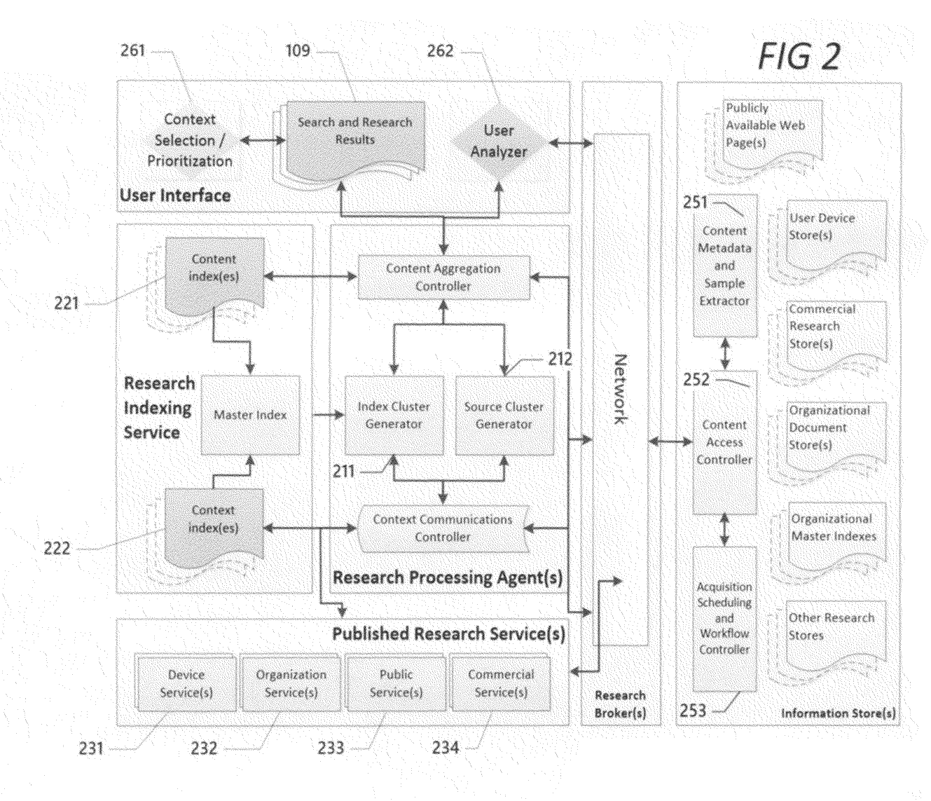

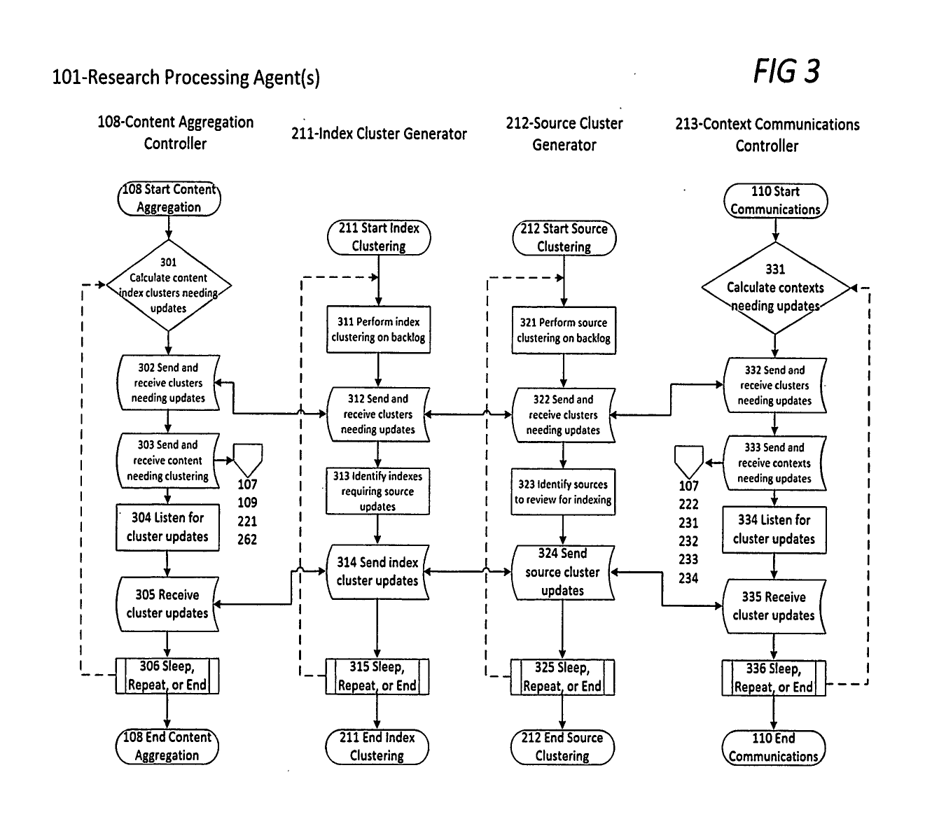

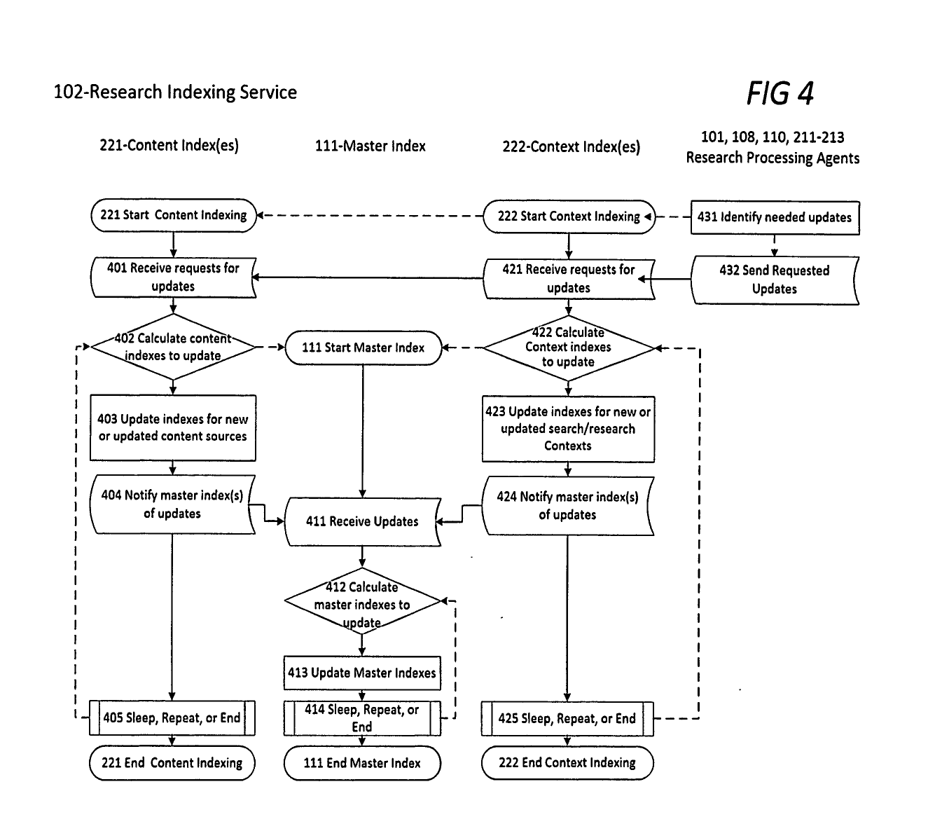

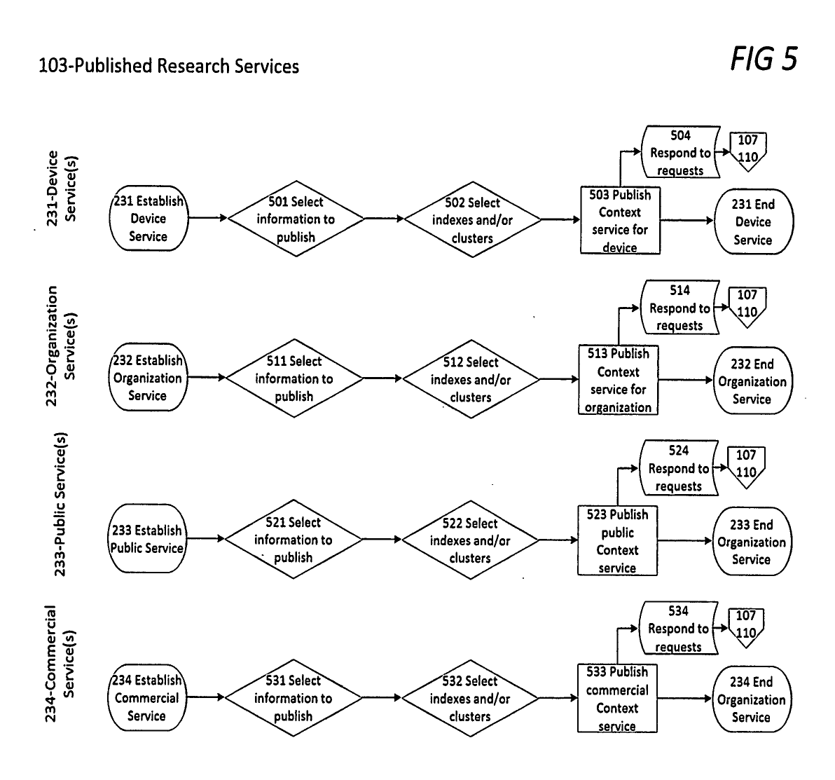

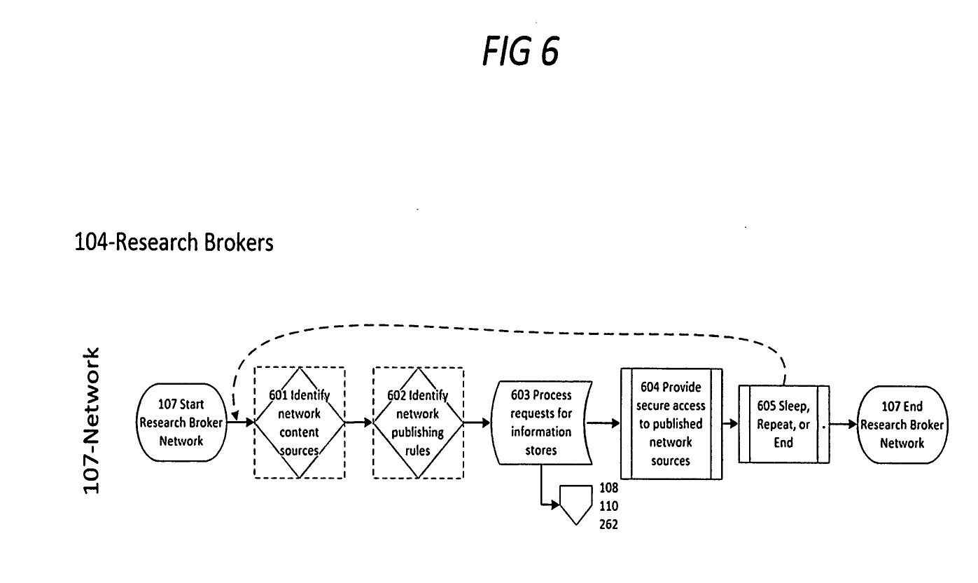

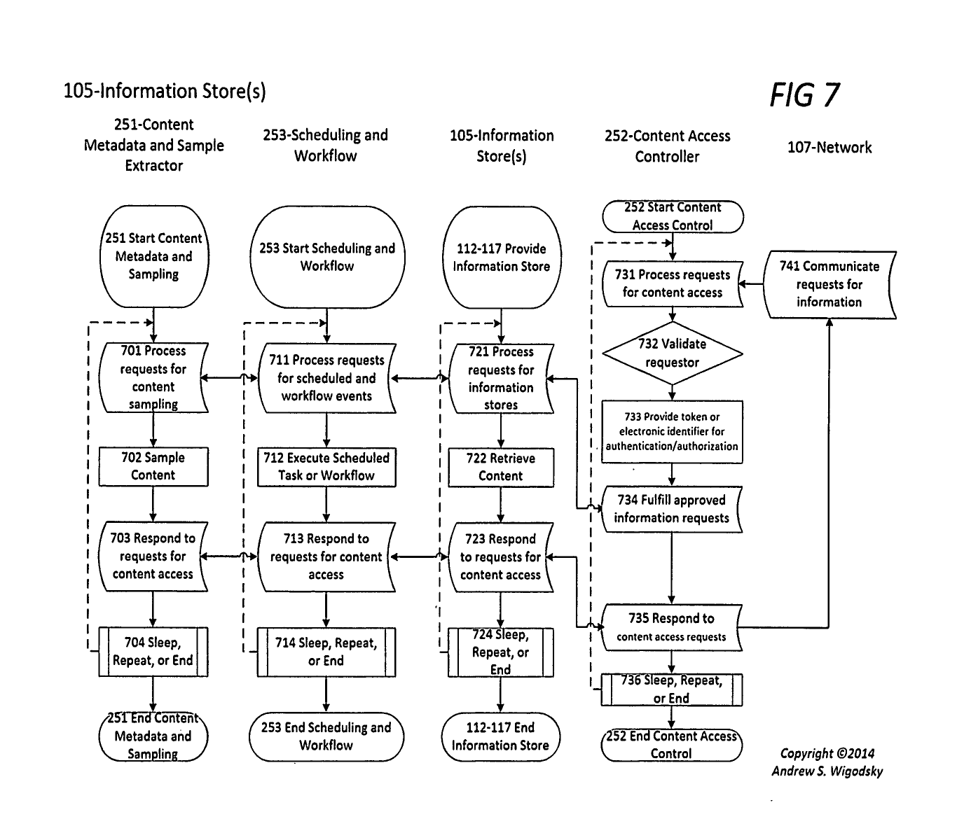

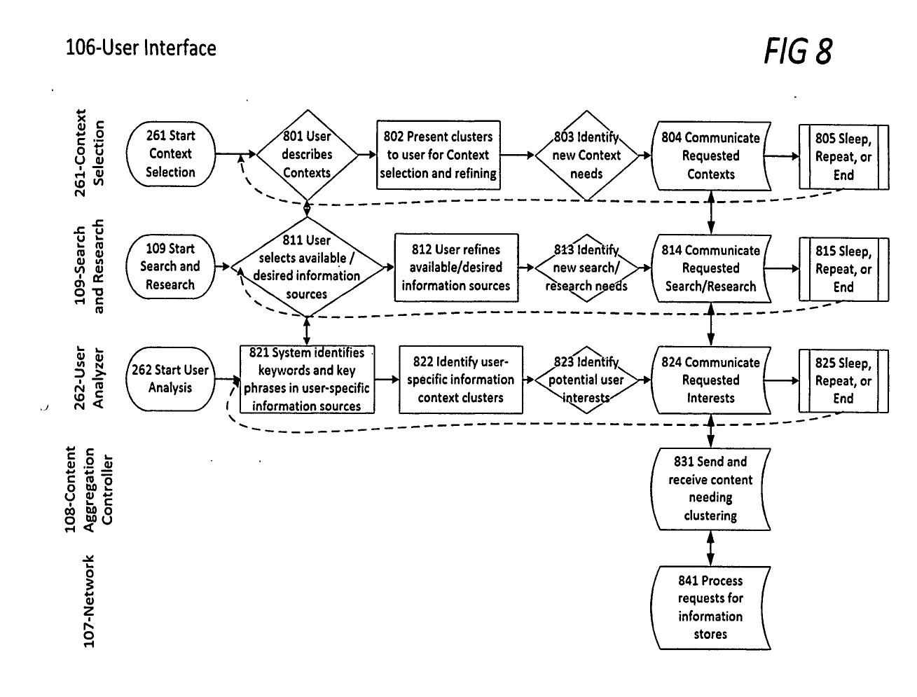

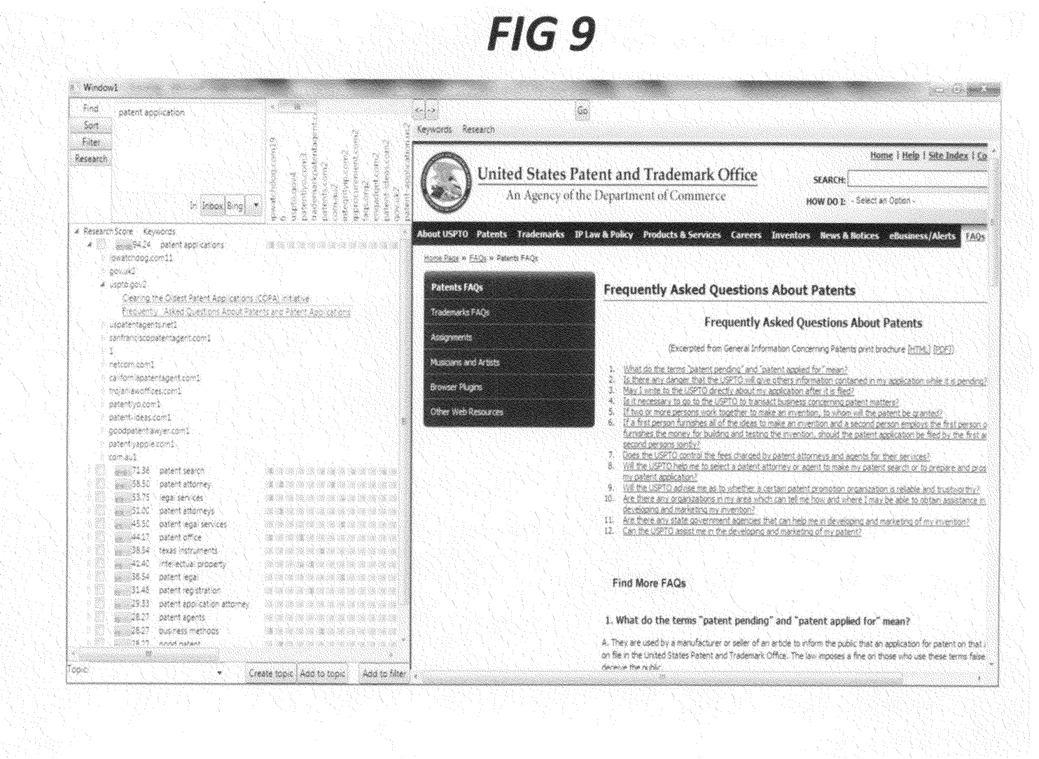

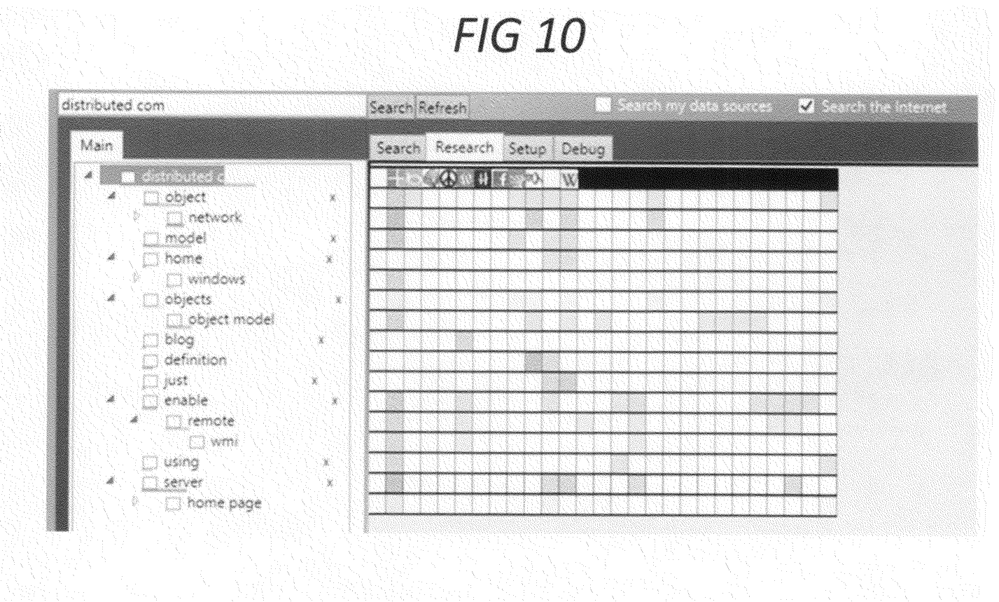

The features of the invention will be better understood by reference to the accompanying drawings which illustrate presently preferred embodiments of the invention. In the drawings:

| | |
|---|---|
| FIG. 1: Basic Collaborative Research Engine | 12 |
| FIG. 2: Advanced Collaborative Research Engine | 13 |
| FIG. 3: Research Processing Agents | 14 |
| FIG. 4: Research Indexing Service | 15 |
| FIG. 5: Published Research Services | 16 |
| FIG. 6: Research Brokers | 17 |
| FIG. 7: Information Stores | 18 |
| FIG. 8: User Interface | 19 |
| FIG. 9: Example user interface | 20 |
| FIG. 10: Example user interface | 20 |

### DETAILED DESCRIPTION OF THE INVENTION

Referring to FIG. 1, a general architecture of the key methods and apparatuses of a collaborative research engine is disclosed. The engine comprises a processing agent [101] or agents, a method or service to index content [102], any number of published service(s) [103], one or a plurality of methods for brokering research [104] optionally over a network [107], at least one information store(s) [105], and any number of user interface(s) [106].

Generally, the processing agent(s) [101] comprise dependent or independent controllers for content aggregation [108] and managing communication of information context [110]. The information store(s) [105] comprise one or a plurality of stores including, but not limited to, data storage containing: publicly available stores [112], user device stores [113], commercial research stores [114], organizational document and message stores [115], organizational master indexes [116], and other information sources and stores [117] containing information that can be found pertinent to a given search or research request. Unlike most current approaches to search or research results, this invention does not prescribe the location of a given information store in relation to the user, and does not prescribe or require a central database of indexed content. Rather, this invention assumes that information is scattered and that an optimal embodiment for finding information comprises communication with other components that already perform the task of indexing content and/or storing indexed content.

Referring to FIG. 2, one preferred embodiment of apparatus 1 is disclosed and referred to as an advanced collaborative research engine. The best mode of the invention involves additional components that enhance features such as the automation of the system, usability of the provided results, and breadth and/or depth of research results provided by the engine: For the research processing agent(s) [101], this can comprise functional enhancements to the agent(s), such as generators for index clusters [211] and source clusters [212]. The research indexing service [102] can be enhanced to comprise specific indexing methods that enhance content indexing [221] and context indexing [222]. Published research services can comprise those published by various entities or devices such as devices [231], organizations [232], for public consumption [233], or commercial service [2]. Additional publishing entities are likely and are comprised within this invention. One optimal embodiment of this invention provides for a device or method enhancements to common information storage mechanisms that improve the contextual search abilities of a given source, such as content and metadata extraction [251], access control to content [252], and workflow such as acquisition task scheduling [253].

Operation of the invention involves certain methods described in FIGS. 3-8. These methods are shown to illustrate the general flow of information between conceptual and logical components of the invention, however it is also contemplated that methods involved can be reordered, refactored, or recomposed to form an optimal embodiment for a given environment or usage.

Referring to FIG. 3, research processing agent[s] use content aggregation [108] and context communications [213] to form clusters of information that can be stored in a local index [211], or can provide a reference to an original source [212].

Content aggregation [108] comprises calculation of content index clusters [301], sending and receiving content clusters requiring updates [302], sending and receiving the content to cluster [303], listening for cluster updates [304], receiving cluster updates [305], and a method to determine whether to sleep, repeat, or end [308]. Index clustering [211] involves a method of clustering indexes [311], sending and receiving clusters [312], identifying indexes that require updated source [313], sending index clusters [314], and a method to determine whether to sleep, repeat, or end [315]. Similarly, source clustering [212] involves methods to perform clustering of content sources [321], sending and receiving clusters [322], identifying sources to review [323], sending source cluster updates [324], and a method to determine whether to sleep, repeat, or end [325]. Once source content and the related indexes have been clustered, a context communications controller [213] determines if any further updates are needed [331], sending and receiving index or source clusters needing updates [332], sending and receiving context descriptions needing updates [333], listening for cluster updates [334], receiving cluster updates [335], and a method to determine whether to sleep, repeat, or end [336].

Referring to FIG. 4, the research indexing service [102] comprises a hybrid or master store containing content and context [111], and in an optimal embodiment, comprises specialized indexing methods for content [221] and specialized indexing methods for context descriptions [222].

A master index comprises methods to receive index updates [411], calculate master indexes requiring updates [412], updating master indexes [413], and a method to determine whether to sleep, repeat, or end [414]. Content indexes [221] comprise methods to receive update requests [401], index update calculation [402], updating indexes for new or updated content sources [403], notifying a master index of updates [404], and a method to determine whether to sleep, repeat, or end [405]. The context indexing service [222] comprises methods to receive update requests [421], calculate context indexes needing updates [422], updating indexes for new or updated contexts [423], notifying a master index of updates [424], and a method to determine whether to sleep, repeat, or end [425]. Each of these indexes [111, 221, 222] can communicate with one or a plurality of research processing agent(s) which identify needed updates [431] and send update requests [432].

It is specifically contemplated that research processing [101] and indexing [102] components can be combined, substituted, or provided by other components commonly available, as long as the basic functions of indexing, processing, and generating or obtaining context descriptions is provided.

Referring to FIG. 5, research publishing [103] includes methods to publish research services for a device [231], organization [232], public or government interest [233], or commercial service [234]. The categories of these services are meant to be representative and not exclusive of other potential publishing entities. These published services comprise a method for information selection [501,511,521,531], methods for selection of individual indexes or context clusters [502,512,522,532], publishing research services [503,513,523,533], and responding to requests [504,514,524,534].

Referring to FIG. 6, a research broker [104] is comprised of a communications network or network(s) [107] facilitating access to research. The operation of a research broker includes methods to identify network content sources [601], publishing rules for a given network [602], processing requests to access information stores [603], providing security [604], and a method to determine whether to sleep, repeat, or end [605].

Referring to FIG. 7, information stores comprise methods and devices for storing information for used by the invention. Generally, these information stores are expected to comprise any information available to a given device or over a communications network to a particular user, and may comprise information that is indirectly available through one or a plurality of connected devices or networks.

In general, this invention only requires a storage medium [105] containing documents, files, or other electronic objects. In an optimal embodiment, one or a plurality of information store[s] are enhanced with features to provide content metadata and sample extraction [251], access control [252], and scheduling and workflow [253]. This communication can take place within an individual device or among a plurality of networked devices.

The operation of the content metadata and sample extractor [251] comprises methods to process requests for content sampling [701], sampling of content [702], responding to requests for content access [703], and a method to determine whether to sleep, repeat, or end [704].

The operation of the content access controller [252] comprises methods to process requests for content access [731], determining authentication and authorization [732], providing a token or other electronic identifier [733], fulfilling approved requests [734], responding to requests [735], and a method to determine whether to sleep, repeat, or end [736].

The operation of the scheduling and workflow [253] comprises methods to schedule and orchestrate tasks and other electronic methods comprising: processing requests for scheduled and workflow events [711], executing scheduled tasks or workflows [712], responding to requests for content access [713], and a method to determine whether to sleep, repeat, or end [714].

The operation of individual methods and devices referred to as information store(s) [112-117] is highly variable and can be specific to a given embodiment or environment.

Referring to FIG. 8, a research engine may provide one or a plurality of devices and methods providing an interface for user interaction [106]. Generally, the user interface is expected to provide methods that allow the user to configure and use the invention. The form of these user interfaces is intentionally flexible, comprising features such as context selection [261], search and research [109], and user analysis [262]. The invention intentionally assumes that components of the user interface may include features not related to the invention, or vice-versa. For example, individual components and features of the invention may be available as part of a website or another product.

The operation of search and research [109] comprises methods to allow users of the invention to select information sources [811], refine available and desired information sources [812], identify new search/research needs [813], communicate requested search/research [814], and a method to determine whether to sleep, repeat, or end [815]. Two illustrations of potential embodiments of the interface for search and research [109] are provided in FIGS. 9-10.

In an optimal embodiment, a method or device referred to as a user analyzer [262] comprises: methods to identify keywords and key phrases in user-specific information sources [821], identify user-specific information contexts clusters [822], identify potential user interests [823], communicate requested interests [824], and a method to determine whether to sleep, repeat, or end [825].

The operation of content selection [261] comprises methods to allow users to describe contexts [801], select and refine context clusters [802], identify new context needs [803], communicate requested contexts [804] and a method to sleep, repeat, or end [805].

Operation of the research engine user interface [106] may also include interfaces to connect with any component of the invention on a device or across a network [841], but must include interfaces to at least one method providing information context and content [831] in response to inquiries.

Although some embodiments are shown to comprise certain features, the applicant specifically contemplates that any feature disclosed herein can be used together or in combination with any other feature on any embodiment of the invention. It is also contemplated that any feature may be specifically excluded from any embodiment of an invention.

What is claimed is:

1. A computer-implemented method of data retrieval, comprising:
responsive to receiving an inquiry;
querying a user to describe the desired research results in terms of key words and phrases in at least one statistical, hierarchical, or referential model;
generate an initial context description comprising one or a plurality of statistical, hierarchical, and reference models;
obtaining the configuration for a particular query and querying at least one storage, processing, or communications medium;
obtaining the context description for one or a plurality of related context descriptions;
discovering, obtaining, and processing context descriptions and associated content or content exemplars from one or a plurality of available documents, electronic communications, web pages, personal device stores, commercial research stores, and organizational information stores;
indexing, storing, processing, and/or communicating indexes that link context descriptions and information stores;
presenting research to a user and enabling a user to refine the previous inquiry;
communicating any new or updated research inquiry.

2. The computer implemented method of claim 1, wherein if a known context description is not found, one or a plurality of research processing agents process steps to generate a new context description from related content in known information stores.

3. The known information stores of claim 2, in an optimal embodiment, further comprising one or a plurality of user-specific or general information stores.

4. The information stores of claim 3, comprising one or a plurality of:
publicly and privately available web pages;
personal device stores;
commercial research stores; and
organizational information stores.

5. The method of claim 2, said processing steps performed by research processing agents comprising:
obtaining and aggregating content;
clustering context descriptions of content sources;
clustering context descriptions of index sources; and
optimally, communicating context descriptions using a communications medium.

6. The processing steps of claim 5, said processing step of obtaining and aggregating content further comprising:
calculating content index clusters needing updates;
sending and receiving clusters of information needing updates;
sending and receiving content needing clustering; and
optimally, listening on a network for cluster updates.

7. The processing steps of claim 5, said processing step of clustering context descriptions of content sources further comprising:
performing source clustering; and
identifying sources to review for further indexing.

8. The processing steps of claim 5, said processing step of clustering context descriptions of index sources further comprising:
performing index clustering; and
identifying indexes requiring source updates.

9. The processing steps of claim 5, said processing step of communicating context descriptions using a communications medium further comprising:
calculating context descriptions needing updates; and
sending and receiving context description updates.

10. The computer implemented method of claim 1, in an optimal embodiment, allowing the user to store and use indexes and reference models for further research;

11. The indexes of claim 10, further comprising:
indexes of content;
indexes of context descriptions; and
hybrid or master indexes.

12. The reference models of claim 10, further comprising:
hyperlinks to content exemplars or previously sampled content;
context descriptions for the referenced content and exemplars

13. The computer implemented method of claim 1, in an optimal embodiment, a method of publishing research services comprising context-enabled content.

14. The method of publishing of claim 13, in an optimal embodiment,

15. The context-enabled content of claim 13, comprising:
content with an embedded context description;
context descriptions with embedded content; or
context descriptions with embedded hyperlinks to content

16. The published context-enabled content of claim 13, comprising context-enabled content stored or owned by a particular entity.

17. The particular entities of claim 16, comprising:
individual person(s) or user(s);
organizations;
public or private entities; and
commercial service.

18. The computer implemented method of claim 1, in an optimal embodiment a network for brokering, exchanging, trading, sharing, and/or selling one or a plurality of context descriptions, associated content, and/or exemplars using a communications network.

19. The network of claim 18, further comprising a network that connects a plurality of computing devices allowing communication of content and context descriptions.

20. The communication of claim 19, in an optimal embodiment, comprising standards for electronic communication of context-enabled information using Internet Protocols.

21. The Internet Protocols of claim 18, comprising protocols describing standards for network communications as issued by an international standards body.

22. The Internet Protocols of claim 20, further comprising protocols describing object notation and web services.

23. The computer implemented method of claim 1, in an optimal embodiment, storing information content in a way that enables one or a plurality of features comprising security, privacy, access control, statistical sampling, metadata analysis, extraction of content exemplars, acquisition scheduling, researcher workflow;

24. The computer implemented method of claim 1, in an optimal embodiment, comprising graphically represented information context descriptions displayed to a user, comprising one or a plurality of discovered information content, links to content, and suggestions for further refining research;
